(19) United States
(12) Patent Application Publication
(10) Pub. No.: US 2011/0157591 A1
(43) Pub. Date: Jun. 30, 2011

(54) MONITORING APPARATUS AND METHOD FOR NANO-TRANSFER PRINTING PROCESS

(76) Inventors: Hong Hocheng, Hsinchu (TW); Wei-Hsuan Hsu, Hsinchu (TW)

(21) Appl. No.: 12/977,053

(22) Filed: Dec. 22, 2010

(30) Foreign Application Priority Data
Dec. 30, 2009 (TW) 098145911

(51) Int. Cl. G01N 21/55

(52) U.S. Cl. 356/445

(57) ABSTRACT

The monitoring apparatus for nano-transfer printing process is installed at a specific location in the surrounding of a transfer printing unit, and, during any stage of the transfer printing process, performs monitoring or measuring the filling height, filling rate and filling profile of the forming material inside the transfer printing unit. The monitoring apparatus includes a detection unit, a measuring unit and an analysis unit. The detection unit emits a detection ray to the transfer printing unit. The measuring unit receives a reaction signal of the detection ray passing through the transfer printing unit. The analysis unit analyzes the reaction signal to determine the filling height, the filling rate and filling profile of the forming material inside the transfer printing unit.

### FIELD OF THE INVENTION

The present invention generally relates to a nano-transfer printing process, and more specifically to a monitoring apparatus and method for nano-transfer printing process.

### BACKGROUND OF THE INVENTION

WIPO No. 2004114016 A2 disclosed a technique only applicable to the condition when the photo-resistance coefficient and the mold refraction coefficient match. When the mold contacts the surface of the polymer, before the polymer fills the mold, the mold cavity is like a complete grating structure. After the polymer fills the mold completely, because the mold and the polymer have close refraction coefficients, the grating effect is removed. In the mean time, the diffraction phenomenon vanishes. This mechanism can be used to detect whether the transfer printing process has finished. However, this technique can only be used when the photo-resistance refraction rate must match the material of the mold.

Taiwan Patent No. 1235628 disclosed a monitoring method and system for transfer printing process. The main feature is to install a plurality of electrode plates on the back of the transfer master mold and the surface of the loading tray for loading wafer substrate respectively to form a plurality of capacitive structures. The result can be used to detect and record the changes of the transfer printing material occurring inside the filling mold cavity. Through thickness change generated by transfer printing material filling the mold cavity and the continuous change of the material characteristics caused by pressed transfer printing material, in turns leading to capacitance change, the method uses the capacitance change signal as the basis for nano-transfer printing process timing. This method is easily affected by the parasitic capacitance on the monitored signal; hence, the precise capacitance is hard to obtain as the basis for finding the filling rate.

Because the scanning electron microscope (SEM) is capable for observing the nano-scale structure, therefore, good and accurate result can be obtain by using SEM to observe the nano-structure. However, for SEM nano-structure observation, the nano-structure must be dried, and electroplated with conductive atoms so that the surface of the nano-structure can attract electron beams. To observe the cross-section of nano-structure, the nano-structure must be cut in the cross-sectional manner and then electroplated with conductive atoms. Although SEM can observe the appearance of the nano-structure, the nano-structure must be destructed. Hence, the nano-structure after SEM photography can no longer be used. In addition, SEM photography must be conducted in vacuum environment and takes a long period of photography to obtain the final result.

### SUMMARY OF THE INVENTION

The monitoring apparatus and method for nano-transfer printing process of the present invention is to determine the filling height, filling rate and the filling profile of transfer printing material based on the surface plasma resonance phenomenon. During the transfer printing process, the transfer printing material will gradually fill the mold cavity. Therefore, during the transfer printing process, the structure and the appearance of the transfer printing material will be different at each stage. The difference will lead to the changes of the condition for surface plasma resonance. On the other hand, the transfer printing material forming process can be estimated via the surface plasma resonance, as the basis for determining the filling height, filling rate and filling profile of the transfer printing material. In addition, when the surface plasma resonance phenomenon no longer changes, the condition indicates that the transfer printing material has completely occupied the mold cavity, and the transfer printing material has already completely duplicate the geometric form of the mold cavity. Hence, the present invention is a simple and accurate method using the condition to determine whether the nano-transfer printing process should terminate. Hence, the present invention can accurately estimate the time required to fill the mold to improve the production efficiency.

The monitoring apparatus for nano-transfer printing process is installed at a specific location in the surrounding of a transfer printing unit, and, during any stage of the transfer printing process, performs monitoring or measuring the filling height, filling rate and filling profile of the filling material inside the transfer printing unit. The monitoring apparatus includes a detection unit, a measuring unit and an analysis unit. The detection unit emits a detection ray to the transfer printing unit. The measuring unit receives a reaction signal of the detection ray passing through the transfer printing unit. The analysis unit analyzes the reaction signal to determine the filling height, filling rate and filling profile of the filling material inside the transfer printing unit.

The monitoring method for nano-transfer printing process of the present invention includes the following steps of:
A. preparing a transfer printing unit: the transfer printing unit including a mold a substrate and a transfer printing material;
B. installing a monitoring apparatus: the monitoring apparatus including a detection unit, a measuring unit, and an analysis unit, and the monitoring apparatus being installed a specific location of the surroundings of the transfer printing unit;
C. emitting detection signal: the detection unit emitting a detection signal at any stage during the transfer printing process, the detection signal passing the transfer printing area of the transfer printing unit;
D. receiving measurement signal: the measuring unit receiving the reaction or at least a signal caused by the detection signal of step C passing through the transfer printing area;
E. analyzing signal: transmitting signal obtained in step D to the analysis unit for analysis or determining the filling height, filling rate and filling profile of the transfer printing; and
F. outputting information: outputting the information of filling height, filling rate and filling profile of the transfer printing for reference for subsequent process.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of a monitoring apparatus for nano-transfer printing process according to the invention;

FIG. 2 shows a schematic view of the application of apparatus according to the present invention;

FIG. 3 shows a schematic view of the monitoring method for nano-transfer printing process according to the invention;

FIG. 4 shows a schematic view of a first exemplary embodiment of the present invention;

FIG. 5 shows a schematic view of a second exemplary embodiment of the present invention;

FIG. 6 shows a schematic view of a third exemplary embodiment of the present invention;

FIG. 7 shows a schematic view of a fourth exemplary embodiment of the present invention; and

FIG. 8 shows schematic view of the application of the present invention to a roller mold.

### DETAILED DESCRIPTION OF THE PREFERRED EMBODIMENTS

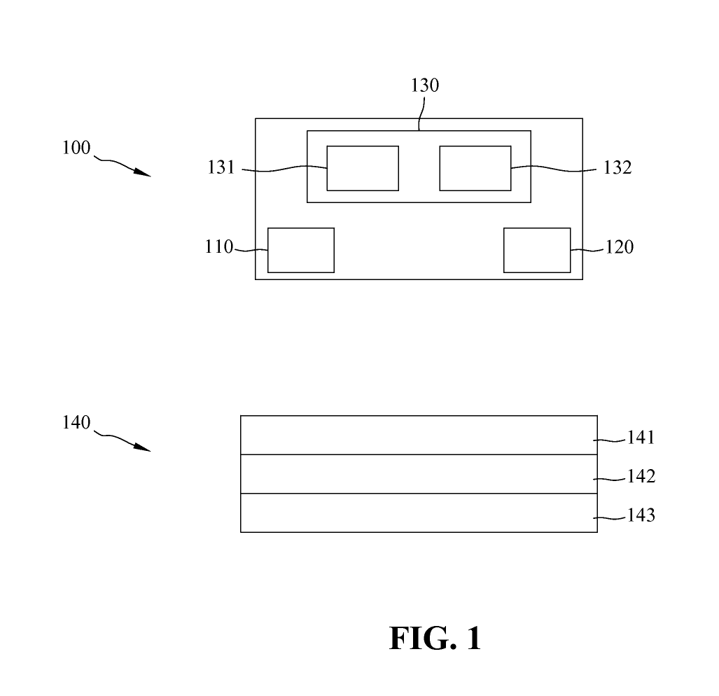

FIG. 1 shows a schematic view of a monitoring apparatus for nano-transfer printing process according to the invention. As shown in FIG. 1, monitoring apparatus 100 for nano-transfer printing process includes a detection unit 110, a measuring unit 120 and an analysis unit 130. Analysis unit 130 further includes a database 131 and at least a signal processing system 132.

Monitoring apparatus 100 for nano-transfer printing process is placed at a specific location in the surroundings of transfer printing unit 140 for monitoring or measuring the forming height, forming rate and forming profile of the forming material inside transfer printing unit 140 at any stage during the transfer printing process. Transfer printing unit 140 includes a mold 141, transfer printing material 142 and a substrate 143. Transfer printing material 142 is located between mold 141 and substrate 143. At least one of mold 141 and substrate 143 includes a metal thin film, a metal structure or one other element able to trigger or cause surface plasma wave.

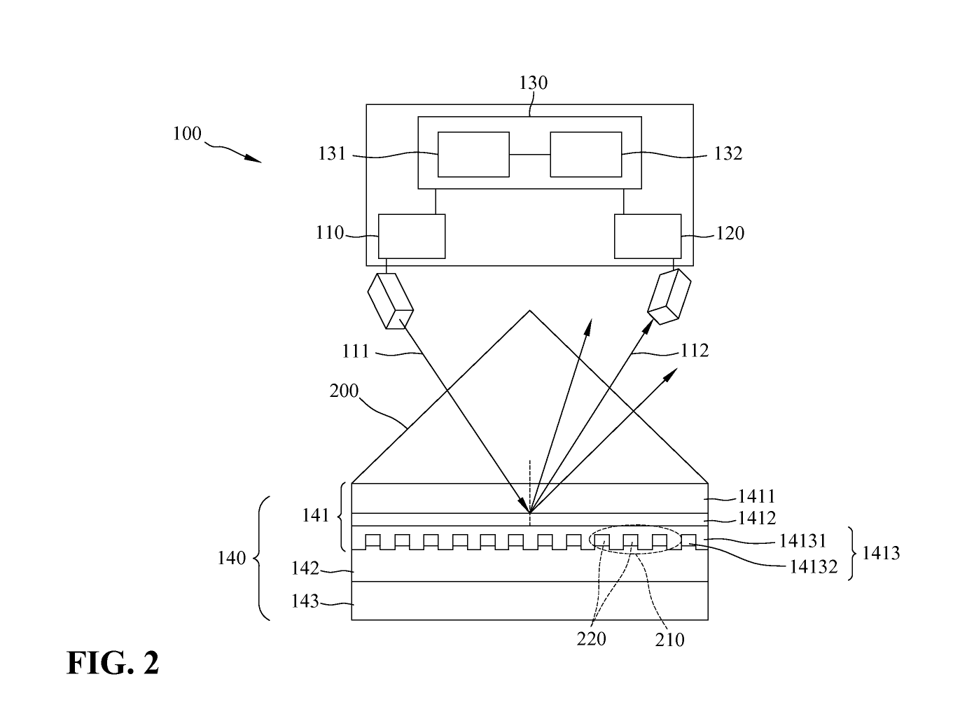

FIG. 2 shows a schematic view of the application of the apparatus of the present invention. As shown in FIG. 2, monitoring apparatus 100 for nano-transfer printing process is placed in the surroundings of transfer printing unit 140. Transfer printing unit 140 includes a mold 141, transfer printing material 142 and a substrate 143. Mold 141 includes a mold substrate 1411, a metal thin film 1412, and at least a feature structure layer 1413 of mold transfer printing. Feature structure layer 1413 includes transfer printing feature structure 14131 and mold cavity 14132 formed by neighboring feature structure 14131. In addition, mold 141 further includes a prism 200 for generating detection signal capable of identifying filling height, filling rate and filling profile of the forming material during the transfer printing process. Signal processing system 132 includes a processor 1321, a display 1322 and a storage element 1323 (not shown).

During the transfer printing process, detection unit 110 placed in the surroundings of transfer printing unit 140 can generate electromagnetic wave of specific or non-specific wavelength, and can emit detection signal 111 to transfer printing unit 140 at a fixed or varying incident angle. Detection signal 111 arrives at metal thin film 1412 and generates surface plasma wave to penetrate feature forming area 210. Feature forming area 210 includes transfer printing feature structure 14131, mold cavity 14132, transfer printing material 142 and unfilled area 220 of mold cavity. After detection signal 111 enters mold 141, detection signal will reach metal thin film 1412 and generate surface plasma wave to penetrate feature forming area 210. The refractive indexes of the areas penetrated by the surface plasma include the following three types: (1) the refractive index of feature structure layer 1413, (2) refractive index of transfer printing material 142 and (3) refractive index of unfilled area 220 of mold cavity. Because unfilled area 220 in mold cavity keeps decreasing during the transfer printing process, and the pressure from transfer printing continues even after the transfer printing material completely fills the mold cavity, leading to the changes of the residual thickness and the uniformity, therefore, the refractive index distribution inside feature forming area 210 will gradually change during the transfer printing process. The aforementioned change will affect the behavior of surface plasma wave vector kₛₚ, which, in turn, affects the condition for the occurrence of surface plasma resonance.

Changing the incident angle of detection unit 110 or wavelength of the electromagnetic wave, and using measuring unit 120 to receive at least a reaction signal of detection signal 111 passing transfer printing unit 140, the received signal is outputted to analysis unit 130. Analysis unit 130 uses signal processing system 132 to analyze the incident angle and wavelength when resonance occurs, and compares with data in database 131 to determine in real-time the forming information of transfer printing material 142 and show on display 1322 (not shown in figure) for the operation reference. The received signal is also stored in database 131 for future experiment reference.

The present invention utilizes the surface plasma resonance phenomenon to detect the filling height, filling rate and filling profile of transfer printing material 142. The surface plasma resonance phenomenon is a collective vibration behavior of the metal surface electrons. By using TM mode ray parallel to incident surface passing through prism 200 and coupled with mold substrate 1411, a surface plasma wave is generated on the surface of another electroplated metal thin film 1412 of mold 141. The electrical field of the surface plasma wave penetrates feature structure 14131 of mold transfer printing, unfilled area 220 and transfer printing material in mold cavity, and gradually fades away along the penetration depth. When the component of wave vector kₓ of detection signal 111 is equal to wave vector kₛₚ of surface plasma wave of the media material (i.e., feature structure 14131 of mold transfer printing, unfilled area 220 and transfer printing material in mold cavity) on the other side of metal thin film 1412, an energy couple resonance phenomenon occurs, that is, “surface plasma resonance”. The resonance will decrease the refractive index of detection signal 111 rapidly, and leaves a downward valley on the refractive index curve. The incident angle corresponding to the lowest refractive index is the resonance angle. The present invention determines the filling height, filling rate and filling profile and filling appearance of the transfer printing material by analyzing the changes of resonance angle.

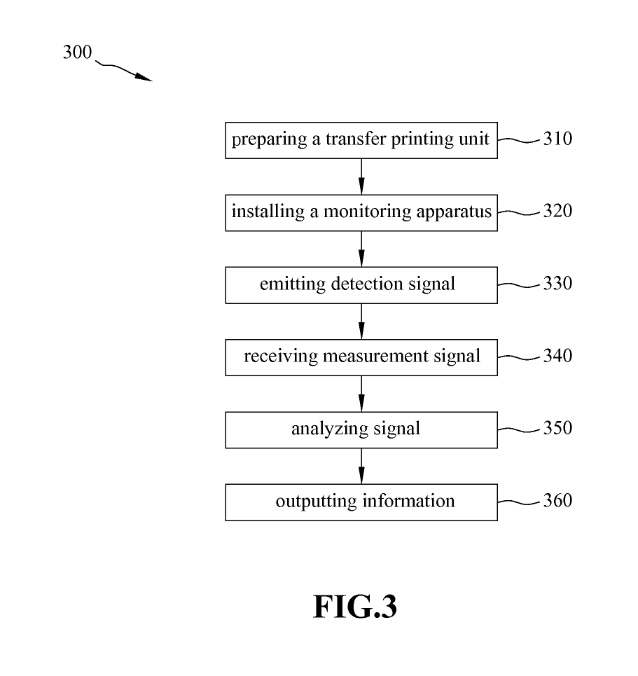

FIG. 3 shows a schematic view of a monitoring method for nano-transfer printing process. As shown in FIG. 3, monitoring method 300 for nano-transfer printing process of the present invention includes the following steps of:
Step 310, preparing a transfer printing unit: the transfer printing unit including a mold a substrate and a transfer printing material;
Step 320, installing a monitoring apparatus: the monitoring apparatus including a detection unit, a measuring unit, and an analysis unit, and the monitoring apparatus being installed a specific location of the surroundings of the transfer printing unit;
Step 330, emitting detection signal: the detection unit emitting a detection signal at any stage during the transfer printing process, the detection signal passing the transfer printing area of the transfer printing unit;
Step 340, receiving measurement signal: the measuring unit receiving the reaction or at least a signal caused by the detection signal of step 330 passing through the transfer printing area;
Step 350, analyzing signal: transmitting signal obtained in step 340 to the analysis unit for analysis or determining the filling height, filling rate, filling appearance and filling profile of the transfer printing; and
Step 360, outputting information: outputting the information of the filling height, filling rate, filling appearance and filling profile of the transfer printing obtained in step 350 for reference for subsequent process.

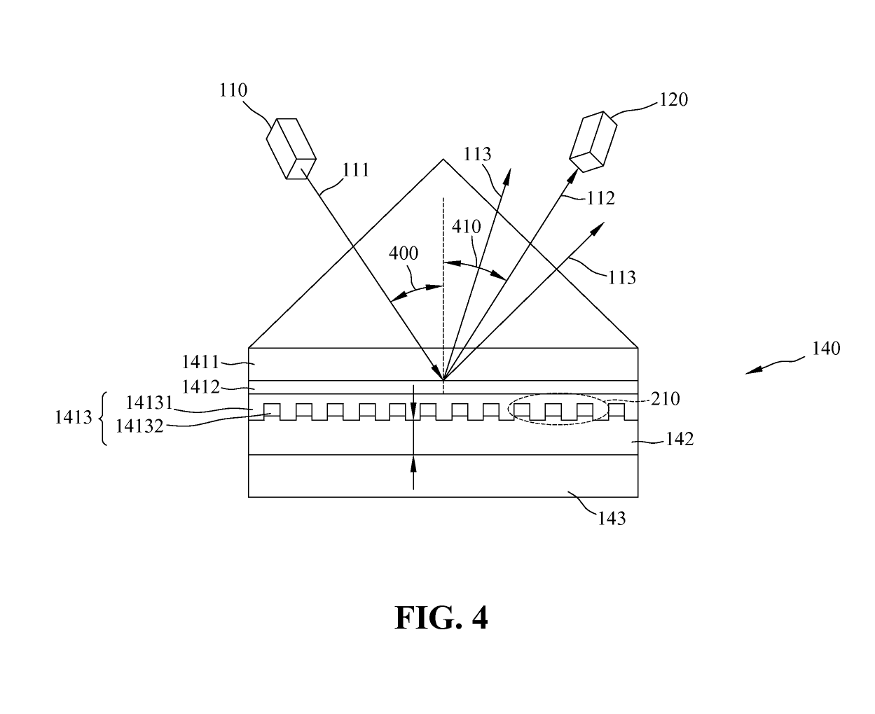

FIG. 4 shows a schematic view of a first exemplary embodiment of the present invention. As shown in FIG. 4, mold substrate 1411 must be made of material that can be penetrated by detection signal 111, and detection unit 110 is placed on the side of the non-transfer printing surface of mold 141 of transfer printing unit 140 for detection. Measuring unit 120 is also placed on the non-transfer printing side of mold 141. Detection unit 110 generates fixed wavelength electromagnetic wave. By changing incident angle 400 of detection signal 111 and placement angle 410 of measuring unit 120, measuring unit 120 can obtain the reaction signals of different incident angles 400. The reaction signal can be reflection signal 112 or diffraction signal 113. To simplify the figure, FIG. 4 only marks ±1 level of diffraction signal 113 and 0 level reflection signal 112, and by no means implying that the present invention is only applicable to measuring ±1 level of diffraction signal or the detection signal can only generate ±1 level of diffraction signal. Measuring unit 120 receives at least one of the above reaction signal, and outputs and analyzes the received signal to determine in real time the surface appearance change of transfer printing material 142, including filling height, filling rate, filling appearance and filling profile.

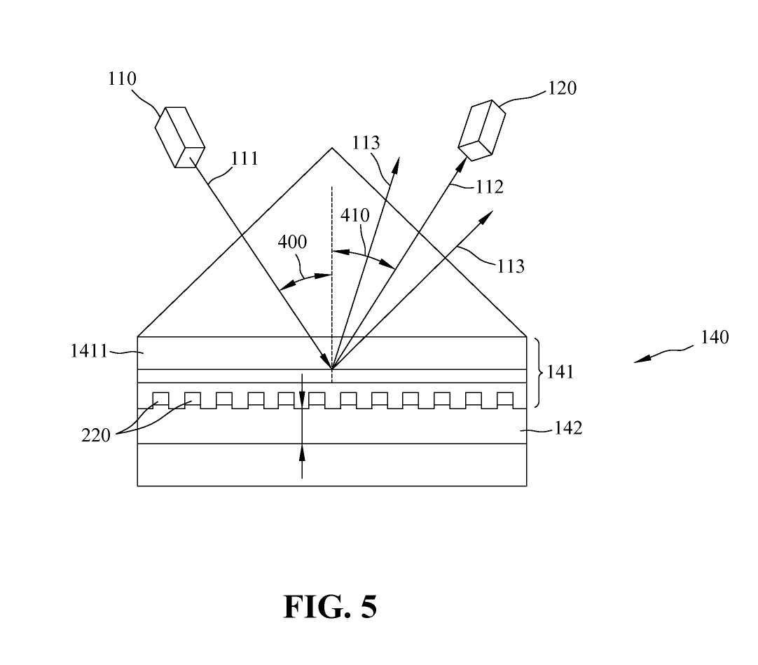

FIG. 5 shows a schematic view of a second exemplary embodiment of the present invention. As shown in FIG. 5, mold substrate 1411 must be made of material that can be penetrated by detection signal 111, and detection unit 110 is placed on the side of the non-transfer printing surface of mold 141 of transfer printing unit 140 for detection. Measuring unit 120 is also placed on the non-transfer printing side of mold 141. Incident angle 400 of detection signal 111 and placement angle 410 of measuring unit 120 are fixed. By using detection unit 110 to generate white light or multiple wavelengths mixed electromagnetic wave, the filling height, filling rate, filling appearance and filling profile information of the transfer printing material can be deduced from the different reaction signals of different wavelengths. The reaction signal can be reflection signal 112 or diffraction signal 113. To simplify the figure, FIG. 5 only marks ±1 level of diffraction signal 113 and 0 level reflection signal 112, and by no means implying that the present invention is only applicable to measuring ±1 level of diffraction signal or the detection signal can only generate ±1 level of diffraction signal. Measuring unit 120 receives at least one of the above reaction signal, and outputs and analyzes the received signal to determine in real time the surface appearance change of transfer printing material 142, including filling height, filling rate, filling appearance and filling profile.

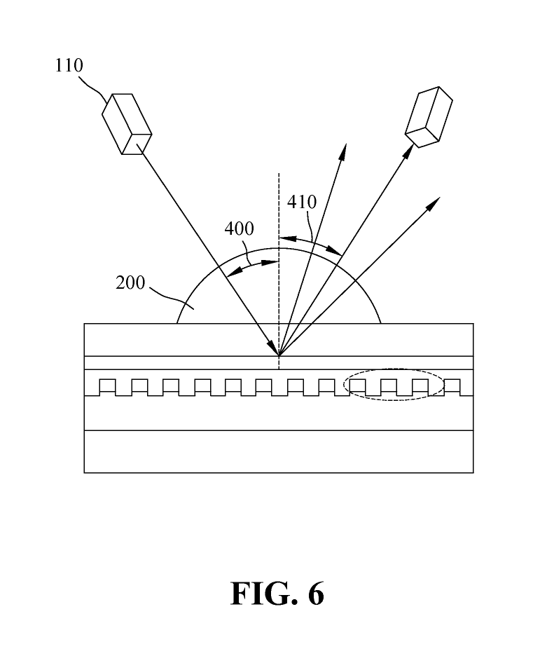

FIG. 6 shows a schematic view of a third exemplary embodiment of the present invention. In the previous embodiments, the monitoring purpose is achieved by changing incident angle 400 or wavelength of detection signal 111 generated by detection unit 110. However, when detection signal 111 passes prism 200, a refraction will occur if detection signal 111 does not enters vertically to the surface. In this manner, the monitoring location of detection signal 111 and the angle at which the reaction signal leaves prism 200 are changed. To improve the above error, prism 200 is changed to a semi-circular column so that detection signal 111 of different wavelengths and different incident angles can enter prism 200 vertically. In this manner, the location of detection signal 111 and the angle at which the reaction signal leaves prism 200 are fixed.

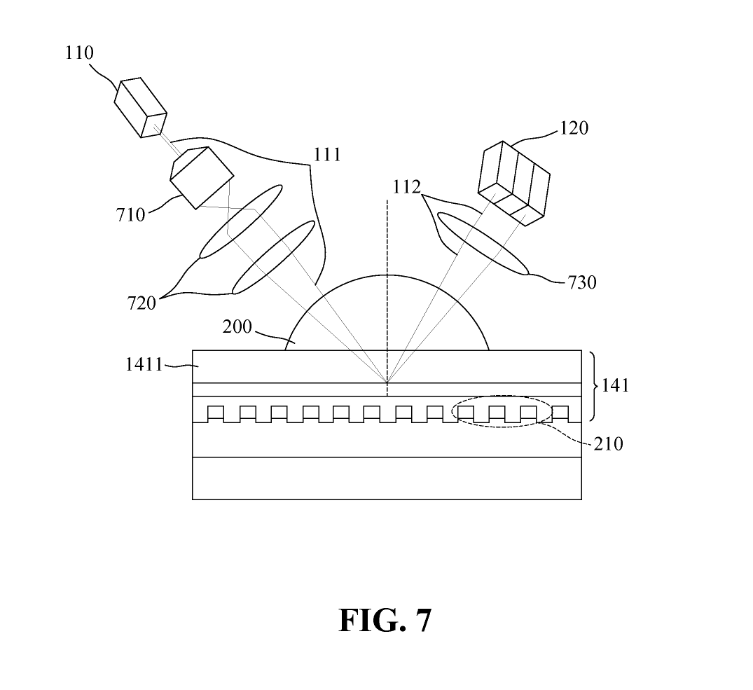

FIG. 7 shows a schematic view of a fourth exemplary embodiment of the present invention. As shown in FIG. 7, mold substrate 1411 must be made of material that can be penetrated by detection signal 111, and detection unit 110 is placed on the side of the non-transfer printing surface of mold 141 of transfer printing unit 140 for detection. Measuring unit 120 is also placed on the non-transfer printing side of mold 141. Detection unit 110 generates a fixed wavelength detection signal 111, and incident angle of detection signal 111 is fixed. Before detection signal 111 enters transfer printing unit 140, a beam-expanding lens set 710 and a first lens set 720 are used to expand detection signal and then focus on the non-transfer printing side of feature forming area 210 of the mold. Reflection signal 112 passing the non-transfer printing side of feature forming area 210 is collected by a second lens set 730 to measuring unit 120 of array arrangement, and reflection signal 112 received by each area of measuring unit 120 is analyzed. When reflection signal 112 received by each area of measuring unit 120 is becoming stable, the condition indicates that the filling height, filling rate, filling appearance and filling profile of transfer printing material 142 no longer change. In other words, transfer printing material 142 has completely filled the mold cavity.

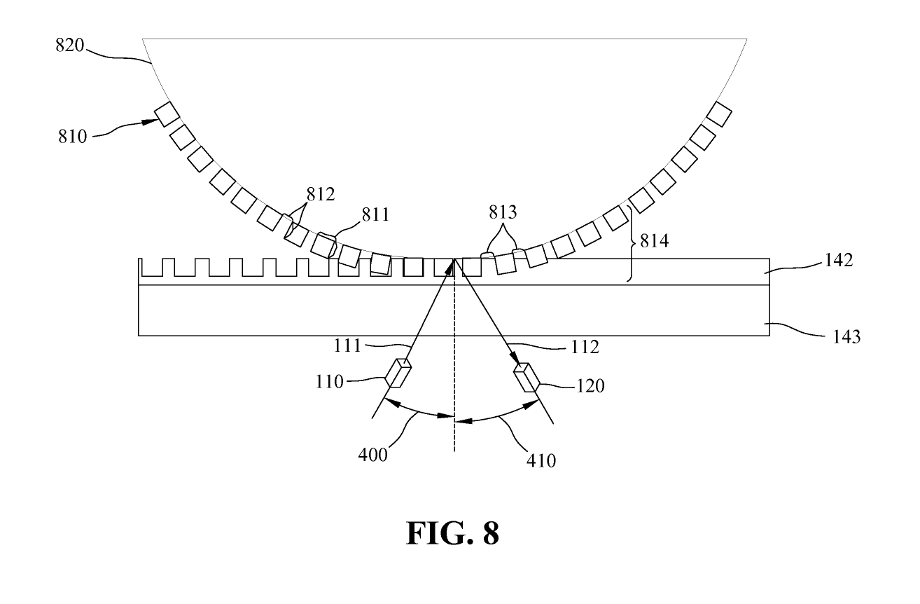

FIG. 8 shows a schematic view of the application of the present invention to the roller mold. As shown in FIG. 8, roller mold 801 is to fabricate micro-structure 811 on the surface of a roller 820, and uses a convey belt system to propel substrate 143 and transfer printing material 142. During the transfer printing process, the transfer printing is accomplished by substrate 143 being moved by the convey belt in combination with the self-rotation of roller 820. Micron-structure 811 on the surface of roller 820 starts the transfer printing upon contacting with transfer printing material 142. With roller 820 continuing rolling, roller 820 will press transfer printing material 142 to fill unfilled area 813 in mold cavity 812. Therefore, the transfer printing process will continue and unfilled area 813 in mold cavity 812 will continue decreasing. When the residual air is completely depleted, micro-structure 811 on roller mold 810 will be duplicated to transfer printing material 142 on the surface of substrate 143. Because the effects of equipment and the environment variation, in actual printing, the residual thickness of transfer printing material 142 often changes, leading to the failure of the final production.

As shown FIG. 8, substrate 143 is a soft transparent thin film, and is made of material that detection signal 111 can penetrate. Detection unit 110 and measuring unit 120 are placed in the surroundings of substrate 143. The size and material of micro-structure 811 of roller mold 810 must be able to trigger or generate surface plasma wave so that feature forming area 814 and detection signal 111 can reach resonance. The resonance can show in reflection signal 112 received by measuring unit 120. Detection signal 111 generated by detection unit 110 can penetrate substrate 143 and enter feature forming area 814. After entering feature forming area 814, detection signal 111 will generate different reaction signals according to the triggering condition of surface plasma wave caused by the refractive index distribution in feature forming area 814. Therefore, with different filling height, filling rate, filling appearance and filling profile of transfer printing material 142, different reaction signals will be obtained. By using measuring unit 120 to receive any reflection signal 112, after outputting and analysis, the surface appearance change, including filling height, filling rate, filling appearance and filling profile of the transfer printing can be determined in real-time. To receive reaction signals of detection signal 111 at different incident angles 400, the placement angle 410 of measuring unit 120 can be changed accordingly.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A monitoring apparatus for nano-transfer printing process, comprising:
a detection unit, further comprising at least a signal generation device, said signal generation device generating at least a detection signal, and said detection signal being emitted or projected to at least an area of a transfer printing unit at least a stage during said transfer printing process or at the end of said process;
a measuring unit, for receiving at least a reaction signal formed by said detection signal; and
an analysis unit, for analyzing said at least a reaction signal received by said measuring unit and transforming said received reaction signal into information of deformation of transfer printing material caused by a mold.

2. The monitoring apparatus as claimed in claim 1, wherein said signal generation device can generate at least a light source of specific wavelength or at least a mixed light source of two wavelengths.

3. The monitoring apparatus as claimed in claim 1, wherein said signal generation device can generate at least a light source with specific polarization characteristics.

4. The monitoring apparatus as claimed in claim 1, wherein said signal generation device can generate at least a linear polarization characteristics light source of a specific direction.

5. The monitoring apparatus as claimed in claim 1, wherein said detection signal can change polarization characteristics through at least an element or a device.

6. The monitoring apparatus as claimed in claim 1, wherein said transfer printing unit further comprises at least a mold, at least a transfer printing material and a substrate; wherein said transfer printing material can attach to surface of said substrate.

7. The monitoring apparatus as claimed in claim 6, wherein said mold further comprises a special element installed on non-transfer printing surface of said mold, said special element is one of a prism, a column-shaped lens or a grating.

8. The monitoring apparatus as claimed in claim 6, wherein at least one of said mold and said substrate comprises an element able to trigger and generate surface plasma wave, said element can be a thin film made of metal, a structure made of metal.

9. The monitoring apparatus as claimed in claim 6, wherein said element able to trigger and generate surface plasma wave can be covered with an adhesive material on surface of said element to improve structure strength of said mold or said substrate.

10. The monitoring apparatus as claimed in claim 1, wherein said reaction signal received by said measuring unit is a reflection signal.

11. The monitoring apparatus as claimed in claim 1, wherein said reaction signal received by said measuring unit is a diffraction signal.

12. The monitoring apparatus as claimed in claim 1, wherein said reaction signal obtained by said measuring unit at least comprises related information of energy strength of said reaction signal.

13. The monitoring apparatus as claimed in claim 1, wherein said reaction signal obtained by said measuring unit at least comprises related information of phase of said reaction signal.

14. The monitoring apparatus as claimed in claim 1, wherein said deformation information of said transfer printing material converted by said analysis unit is depth related information of said transfer printing material filling into structure of said transfer printing surface of said mold.

15. The monitoring apparatus as claimed in claim 1, wherein said deformation information of said transfer printing material converted by said analysis unit is related information of gap volume between said transfer printing material and said transfer printing surface of said mold.

16. The monitoring apparatus as claimed in claim 1, wherein said analysis unit further comprises a signal processing system, said at least a signal processing system further comprises a processor, a signal display device and a storage element, said storage element comprises at least a set of information corresponding to related information of reaction signal and deformation of transfer printing material.

17. The monitoring apparatus as claimed in claim 16, wherein said storage element records at least a set of information corresponding to related information of reaction signal and deformation of transfer printing material.

18. The monitoring apparatus as claimed in claim 16, wherein said display device displays related information of reaction signal or deformation of transfer printing material.

19. The monitoring apparatus as claimed in claim 16, wherein said signal processing system at least comprises a device able to transmit a feedback signal for determining related information of deformation of transfer printing material and for determining whether said transfer printing process is completed.

20. A monitoring method for residual thickness and uniformity of nano-transfer printing process, comprising the steps of:
A. preparing a transfer printing unit: said transfer printing unit comprising a mold a substrate and a transfer printing material;
B. installing a monitoring apparatus: said monitoring apparatus comprising a detection unit, a measuring unit, and an analysis unit, and said monitoring apparatus being installed at a specific location of the surroundings of said transfer printing unit; wherein said detection unit comprising at least a signal generation device, said at least a signal generation device generating at least a detection signal;
C. emitting detection signal: said detection unit emitting a detection signal at any stage during said transfer printing process, said detection signal passing transfer printing area of said transfer printing unit;
D. receiving measurement signal: said measuring unit receiving at least a reaction signal or at least a change signal caused by the detection signal of said step C passing through said transfer printing area;
E. analyzing signal: transmitting signal obtained in said step D to said analysis unit for analysis or determining related information of deformation of said transfer printing material caused by a mold, and to evaluate the extent of completion of said transfer printing process; and
F. outputting information: outputting information of said related information of deformation of transfer printing material caused by said mold obtained in said step E for reference for subsequent process.

21. The monitoring method as claimed in claim 20, wherein said mold is for manufacturing micro-structure.

22. The monitoring method as claimed in claim 20, wherein said transfer printing structure for said transfer printing unit comprises at least a periodic structure.

23. The monitoring method as claimed in claim 20, wherein said transfer printing structure for said transfer printing unit comprises at least a non-periodic structure.

24. The monitoring method as claimed in claim 20, wherein said signal generation device can generate at least a light source of specific wavelength or at least a mixed light source of two wavelengths.

25. The monitoring method as claimed in claim 20, wherein said signal generation device can generate at least a light source with specific polarization characteristics.

26. The monitoring method as claimed in claim 20, wherein said signal generation device can generate at least a linear polarization characteristics light source of a specific direction.

27. The monitoring method as claimed in claim 20, wherein at least an element or device is placed between said signal generation device and said transfer printing unit so as to change polarization characteristics of said detection signal.

28. The monitoring method as claimed in claim 20, wherein said mold further comprises a special element installed on non-transfer printing surface of said mold, said special element is one of a prism, a column-shaped lens or a grating.

29. The monitoring apparatus as claimed in claim 20, wherein at least one of said mold and said substrate comprises an element able to trigger and generate surface plasma wave, said element can be a thin film made of metal, a structure made of metal.

30. The monitoring apparatus as claimed in claim 29, wherein said element able to trigger and generate surface plasma wave can be covered with an adhesive material on surface of said element to improve structure strength of said mold or said substrate.

31. The monitoring method as claimed in claim 20, wherein incident angle adopted by said detection signal in said step (C) to said transfer printing unit is a fixed angle.

32. The monitoring method as claimed in claim 20, wherein incident angle adopted by said detection signal in said step (C) to said transfer printing unit varies.

33. The monitoring method as claimed in claim 20, wherein said detection signal in said step (C) enters at least an area of said transfer printing unit, sand said at least an area is at least a part of inside of said mold.

34. The monitoring method as claimed in claim 20, wherein said detection signal in said step (C) enters at least an area of said transfer printing unit, sand said at least an area is at least a part of gap between said transfer printing surface of said mold and said transfer printing material.

35. The monitoring method as claimed in claim 20, wherein said detection signal is emitted or projected to at least an area of said transfer printing unit, sand said at least an area is at least a part of inside of said transfer printing material.

36. The monitoring method as claimed in claim 20, wherein said received signal of said step (D) at least comprises related information of an energy strength of detection signal.

37. The monitoring method as claimed in claim 20, wherein said received signal of said step (D) at least comprises related information of phase of detection signal.

38. The monitoring method as claimed in claim 20, wherein said related information of deformation of said transfer printing material caused by said mold to be analyzed, compared and determined in said step (E) is depth related information of said transfer printing material filling into structure of said transfer printing surface of said mold.

39. The monitoring method as claimed in claim 20, wherein said related information of deformation of said transfer printing material caused by said mold to be analyzed, compared and determined in said step (E) is related information of gap volume between said transfer printing material and said transfer printing surface of said mold.
